(19) United States
(12) Patent Application Publication
(10) Pub. No.: US 2007/0242445 A1
(43) Pub. Date: Oct. 18, 2007

(54) El Sheet Keypad

(75) Inventors: Dong Hyuk Shin, Seoul (KR); Kwang Hyuk Bae, Daejeon (KR); Wonbong Jang, Daejeon (KR)

Correspondence Address: OLIFF & BERRIDGE, PLC, P.O. BOX 19928, ALEXANDRIA, VA, 22320, US

(73) Assignee: EL KOREA CORPORATION, DAEJEON-GU (KR)

(21) Appl. No.: 11/579,046

(22) PCT Filed: Mar. 14, 2005
(86) PCT No.: PCT/KR05/00717

§ 371 Date: Oct. 30, 2006

(30) Foreign Application Priority Data
May 7, 2004 (KR) 10-2004-0032309

(51) Int. Cl. H04M 1/22

(52) U.S. Cl. 362/24

(57) ABSTRACT

An EL sheet keypad comprises a conductive material layer coated on the entire surface of an EL sheet or the surface of the EL sheet where light is not emitted. The conductive material layer is connected to ground of a printed circuit board or to ground of the EL sheet by means of a conductive adhesive tape or conductive paste. According to the present invention, damage to the internal circuits of the mobile phone, which may occur when testing appropriateness of the EL sheet, is prevented. Furthermore, the EL sheet keypad has electrostatic shock and electromagnetic interference shielded functions.

### TECHNICAL FIELD

The present invention relates to an EL sheet keypad, and, more particularly, to an EL sheet keypad having an electrostatic discharge layer.

### BACKGROUND ART

When an electro luminescence (hereinafter, referred to as “EL”) device is used to illuminate a keypad of a mobile phone instead of a conventional light emitting diode to (hereinafter, referred to as “LED”), visibility is improved, and power consumption is low. Furthermore, the EL device is manufactured with various colors.

FIG. 1 is a view schematically showing an example of a conventional EL sheet keypad, i.e., a conventional EL sheet keypad using metal or poly domes.

Referring to FIG. 1, the conventional EL sheet keypad comprises an EL dome sheet composed of an EL sheet and metal domes attached to the EL sheet by means of a double-sided adhesive tape, a printed circuit board, and a rubber keypad.

FIG. 2 is a view schematically showing an EL sheet used in the conventional EL sheet keypad, and FIG. 3 is a view schematically showing a printed circuit board used in the conventional EL sheet keypad.

Referring to FIG. 2, the EL sheet 10 has an electric current supplying terminal and light-emitting surfaces 11 from which light is emitted when electric current is supplied.

Referring to FIG. 3, the printed circuit board 20 comprises a plurality of unit circuits, an electric current supplying unit for supplying electric current to the EL sheet, and grounding electrodes 21.

It is necessary that the EL device pass several tests, unlike a conventional EL device used in the conventional LCD backlight, to use the EL device as an illuminating device for illuminating a keypad of a mobile phone. One of the tests is an electrostatic discharge (ESD) resistance test for testing whether the EL device can resist static electricity generated when the mobile phone is used. The EL device used for illuminating a keypad of a mobile phone does not have any electrostatic discharge protection structure unlike the conventional LCD backlight. A user of the mobile phone frequently touches the keypad of the mobile phone, and therefore, static electricity may be easily generated from the keypad of the mobile phone. The static electricity is an induced electric charge having a high voltage of tens to tens of thousands of volts with a high frequency of hundreds of thousands of hertz, and therefore, the static electricity may seriously damage internal circuits of the mobile phone. For this reason, the electrostatic discharge resistance test is necessary.

The electrostatic discharge resistance test is performed by applying a high-voltage with high-frequency to the EL device in the mobile phone through a mobile phone case. The applied high-voltage with high-frequency is discharged to a drive circuit through a bus bar in the EL device with the result that an inverter device is destroyed.

Consequently, internal circuits of the mobile phone may be damaged when performing a test to determine whether the EL device can be appropriately used as an illuminating device for illuminating the keypad of the mobile phone.

### DISCLOSURE

### Technical Problem

Therefore, the present invention has been made in view of the above problems, and it is an object of the present invention to provide an EL sheet keypad that is capable of protecting internal circuits of a mobile phone from electric shocks when an electrostatic discharge resistance test of a keypad of the mobile phone is performed.

### TECHNICAL SOLUTION

In accordance with one aspect of the present invention, the above and other objects can be accomplished by the provision of an EL sheet keypad comprising: a printed circuit board having a circuit and grounding electrodes formed thereon; and an EL sheet attached to the printed circuit board, wherein the improvement comprises:

a conductive material layer coated on the entire surface of the EL sheet or the surface of the EL sheet where light is not emitted, the conductive material layer being connected to the ground of the printed circuit board by means of a conductive adhesive tape or conductive paste.

In accordance with another aspect of the present invention, there is provided an EL sheet keypad comprising: a printed circuit board; and an EL sheet attached to the printed circuit board while a drive circuit of the EL sheet is connected to ground of the printed circuit board, wherein the improvement comprises: a conductive material layer coated on the entire surface of the EL sheet or the surface of the EL sheet where light is not emitted, the conductive material layer being connected to front electrodes for supplying electric current to the drive circuit by means of a conductive adhesive tape or conductive paste.

Preferably, the conductive material layer is formed in a net pattern including empty spaces each having a diameter of not more than 0.6 mm.

### ADVANTAGEOUS EFFECTS

According to the present invention with the above-stated construction, the conductive material coating layer is formed on the EL sheet as an electrostatic discharge layer. Consequently, a high-voltage with high-frequency applied when performing an electrostatic discharge resistance test is discharged through the ground of the printed circuit board or through the ground connected to the drive circuit of the EL sheet. As a result, damage to internal circuits of a mobile phone, which may occur when testing appropriateness of the EL sheet, is prevented.

Furthermore, the EL sheet keypad is not affected by external electrostatic shocks. Especially, the EL sheet keypad has electrostatic shock and electromagnetic interference shielded functions.

### DESCRIPTION OF DRAWINGS

The above and other objects, features and other advantages of the present invention will be more clearly understood from the following detailed description taken in conjunction with the accompanying drawings, in which:

FIG. 1 is a view schematically showing an example of a conventional EL sheet keypad, i.e., a conventional EL sheet keypad using metal or poly domes;

FIG. 2 is a view schematically showing an EL sheet used in the conventional EL sheet keypad;

FIG. 3 is a view schematically showing a printed circuit board used in the conventional EL sheet keypad; and

FIG. 4 is a view schematically showing an EL sheet keypad according to a preferred embodiment of the present invention.

### BEST MODE

Now, a preferred embodiment of the present invention will be described in detail with reference to the accompanying drawings.

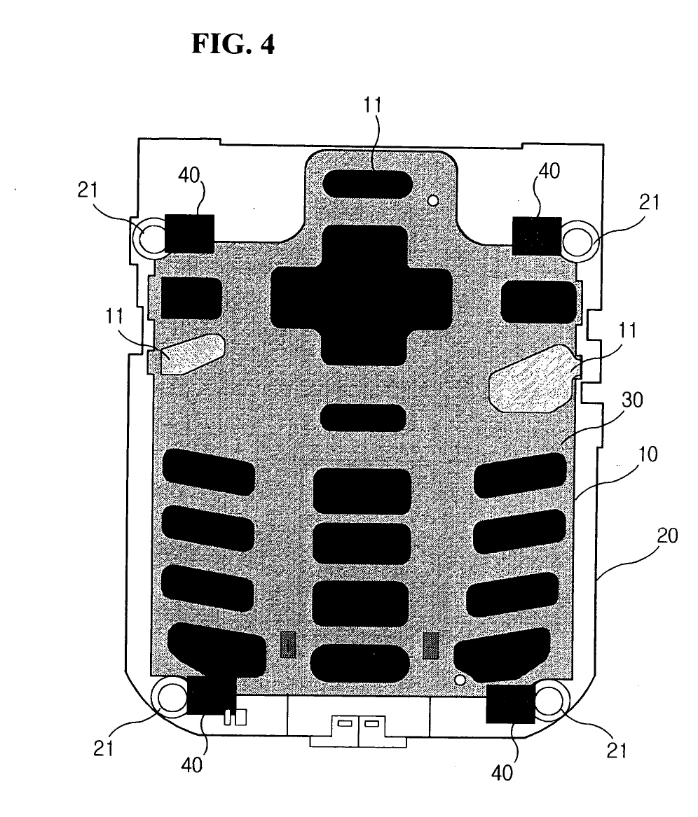

FIG. 4 is a view schematically showing an EL sheet keypad according to a preferred embodiment of the present invention.

Referring to FIG. 4, the EL sheet keypad according to the preferred embodiment of the present invention comprises an EL sheet 10 and a printed circuit board 20, as in the prior art.

The entire surface of the EL sheet 10 or the surface of the EL sheet where light is not emitted is coated with a conductive material. A conductive material coating layer 30 is formed by printing a conductive material containing metal powder including silver on the surface of the EL sheet where light is not emitted in a screen printing fashion or printing a transparent conductive material on the entire surface of the EL sheet in the screen printing fashion.

The conductive material coating layer 30 prepared as described above is connected to ground 21 of the printed circuit board 20 by means of an appropriate conductive bonding agent, such as a conductive adhesive tape 40 or conductive paste.

A drive circuit of the EL sheet may be connected to the ground, if necessary. In this case, the conductive material coating layer is preferably formed on the front electrodes of the EL sheet connected to the drive circuit of the EL sheet for supplying electric current to the drive circuit.

Consequently, the high-voltage with high-frequency applied when performing an electrostatic discharge resistance test is discharged not through a bus bar in the EL sheet 10 but through the ground 21 of the printed circuit board 20 or through the ground connected to the drive circuit of the EL sheet. As a result, damage to the internal circuits of the mobile phone, which may occur when testing appropriateness of the EL sheet, is prevented.

When embodying the present invention, the conductive material coating layer 30 must have a low resistance, which is required to form a stable and uniform electric potential surface and discharge quickly. Specifically, it should be considered that stable electric potential is formed without affecting internal frequency and internal circuits of the mobile phone when designing the conductive material coating layer 30. Consequently, the resistance of the conductive material coating layer 30 is preferably not more than 10Ω. More preferably, the resistance of the conductive material coating layer 30 is preferably not more than 2Ω to pass all of the tests related to electromagnetic interference as well as the electrostatic discharge. To this end, the conductive material coating layer 30 is formed in a net pattern including empty spaces each having a diameter of not more than 0.6 mm, or coated on the entire surface of the EL sheet 10.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

### TECHNICAL FIELD

The present invention relates to an EL sheet keypad, and, more particularly, to an EL sheet keypad having an electrostatic discharge layer.

### BACKGROUND ART

When an electro luminescence (hereinafter, referred to as “EL”) device is used to illuminate a keypad of a mobile phone instead of a conventional light emitting diode (hereinafter, referred to as “LED”), visibility is improved, and power consumption is low. Furthermore, the EL device is manufactured with various colors.

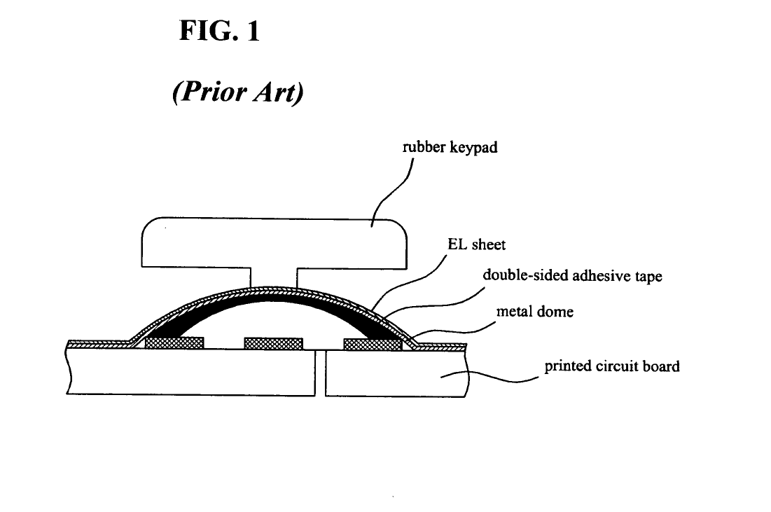

FIG. 1 is a view schematically showing an example of a conventional EL sheet keypad, i.e., a conventional EL sheet keypad using metal or poly domes.

Referring to FIG. 1, the conventional EL sheet keypad comprises an EL dome sheet composed of an EL sheet and metal domes attached to the EL sheet by means of a double-sided adhesive tape, a printed circuit board, and a rubber keypad.

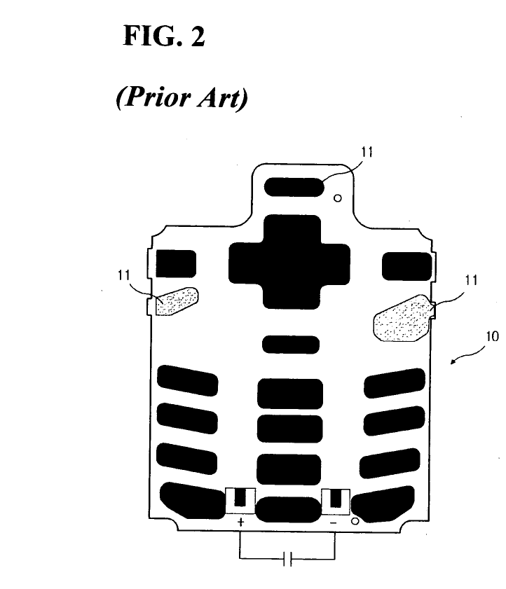

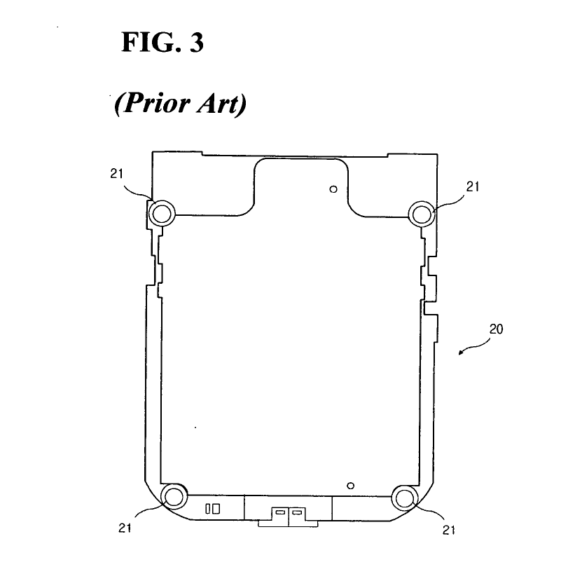

FIG. 2 is a view schematically showing an EL sheet used in the conventional EL sheet keypad, and FIG. 3 is a view schematically showing a printed circuit board used in the conventional EL sheet keypad.

Referring to FIG. 2, the EL sheet 10 has an electric current supplying terminal and light-emitting surfaces 11 from which light is emitted when electric current is supplied.

Referring to FIG. 3, the printed circuit board 20 comprises a plurality of unit circuits, an electric current supplying unit for supplying electric current to the EL sheet, and grounding electrodes 21.

It is necessary that the EL device pass several tests, unlike a conventional EL device used in the conventional LCD backlight, to use the EL device as an illuminating device for illuminating a keypad of a mobile phone. One of the tests is an electrostatic discharge (ESD) resistance test for testing whether the EL device can resist static electricity generated when the mobile phone is used. The EL device used for illuminating a keypad of a mobile phone does not have any electrostatic discharge protection structure unlike the conventional LCD backlight. A user of the mobile phone frequently touches the keypad of the mobile phone, and therefore, static electricity may be easily generated from the keypad of the mobile phone. The static electricity is an induced electric charge having a high voltage of tens to tens of thousands of volts with a high frequency of hundreds of thousands of hertz, and therefore, the static electricity may seriously damage internal circuits of the mobile phone. For this reason, the electrostatic discharge resistance test is necessary.

The electrostatic discharge resistance test is performed by applying a high-voltage with high-frequency to the EL device in the mobile phone through a mobile phone case. The applied high-voltage with high-frequency is discharged to a drive circuit through a bus bar in the EL device with the result that an inverter device is destroyed.

Consequently, internal circuits of the mobile phone may be damaged when performing a test to determine whether the EL device can be appropriately used as an illuminating device for illuminating the keypad of the mobile phone.

### DISCLOSURE

### Technical Problem

Therefore, the present invention has been made in view of the above problems, and it is an object of the present invention to provide an EL sheet keypad that is capable of protecting internal circuits of a mobile phone from electric shocks when an electrostatic discharge resistance test of a keypad of the mobile phone is performed.

### TECHNICAL SOLUTION

In accordance with one aspect of the present invention, the above and other objects can be accomplished by the provision of an EL sheet keypad comprising: a printed circuit board having a circuit and grounding electrodes formed thereon; and an EL sheet attached to the printed circuit board, wherein the improvement comprises:

a conductive material layer coated on the entire surface of the EL sheet or the surface of the EL sheet where light is not emitted, the conductive material layer being connected to the ground of the printed circuit board by means of a conductive adhesive tape or conductive paste.

In accordance with another aspect of the present invention, there is provided an EL sheet keypad comprising: a printed circuit board; and an EL sheet attached to the printed circuit board while a drive circuit of the EL sheet is connected to ground of the printed circuit board, wherein the improvement comprises: a conductive material layer coated on the entire surface of the EL sheet or the surface of the EL sheet where light is not emitted, the conductive material layer being connected to front electrodes for supplying electric current to the drive circuit by means of a conductive adhesive tape or conductive paste.

Preferably, the conductive material layer is formed in a net pattern including empty spaces each having a diameter of not more than 0.6 mm.

### ADVANTAGEOUS EFFECTS

According to the present invention with the above-stated construction, the conductive material coating layer is formed on the EL sheet as an electrostatic discharge layer. Consequently, a high-voltage with high-frequency applied when performing an electrostatic discharge resistance test is discharged through the ground of the printed circuit board or through the ground connected to the drive circuit of the EL sheet. As a result, damage to internal circuits of a mobile phone, which may occur when testing appropriateness of the EL sheet, is prevented.

Furthermore, the EL sheet keypad is not affected by external electrostatic shocks. Especially, the EL sheet keypad has electrostatic shock and electromagnetic interference shielded functions.

### DESCRIPTION OF DRAWINGS

The above and other objects, features and other advantages of the present invention will be more clearly understood from the following detailed description taken in conjunction with the accompanying drawings, in which:

FIG. 1 is a view schematically showing an example of a conventional EL sheet keypad, i.e., a conventional EL sheet keypad using metal or poly domes;

FIG. 2 is a view schematically showing an EL sheet used in the conventional EL sheet keypad;

FIG. 3 is a view schematically showing a printed circuit board used in the conventional EL sheet keypad; and

FIG. 4 is a view schematically showing an EL sheet keypad according to a preferred embodiment of the present invention.

### BEST MODE

Now, a preferred embodiment of the present invention will be described in detail with reference to the accompanying drawings.

FIG. 4 is a view schematically showing an EL sheet keypad according to a preferred embodiment of the present invention.

Referring to FIG. 4, the EL sheet keypad according to the preferred embodiment of the present invention comprises an EL sheet 10 and a printed circuit board 20, as in the prior art.

The entire surface of the EL sheet 10 or the surface of the EL sheet where light is not emitted is coated with a conductive material. A conductive material coating layer 30 is formed by printing a conductive material containing metal powder including silver on the surface of the EL sheet where light is not emitted in a screen printing fashion or printing a transparent conductive material on the entire surface of the EL sheet in the screen printing fashion.

The conductive material coating layer 30 prepared as described above is connected to ground 21 of the printed circuit board 20 by means of an appropriate conductive bonding agent, such as a conductive adhesive tape 40 or conductive paste.

A drive circuit of the EL sheet may be connected to the ground, if necessary. In this case, the conductive material coating layer is preferably formed on the front electrodes of the EL sheet connected to the drive circuit of the EL sheet for supplying electric current to the drive circuit.

Consequently, the high-voltage with high-frequency applied when performing an electrostatic discharge resistance test is discharged not through a bus bar in the EL sheet 10 but through the ground 21 of the printed circuit board 20 or through the ground connected to the drive circuit of the EL sheet. As a result, damage to the internal circuits of the mobile phone, which may occur when testing appropriateness of the EL sheet, is prevented.

When embodying the present invention, the conductive material coating layer 30 must have a low resistance, which is required to form a stable and uniform electric potential surface and discharge quickly. Specifically, it should be considered that stable electric potential is formed without affecting internal frequency and internal circuits of the mobile phone when designing the conductive material coating layer 30. Consequently, the resistance of the conductive material coating layer 30 is preferably not more than 10Ω. More preferably, the resistance of the conductive material coating layer 30 is preferably not more than 2Ω to pass all of the tests related to electromagnetic interference as well as the electrostatic discharge. To this end, the conductive material coating layer 30 is formed in a net pattern including empty spaces each having a diameter of not more than 0.6 mm, or coated on the entire surface of the EL sheet 10.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. An EL sheet keypad comprising: a printed circuit board having a circuit and ground formed thereon; and an EL sheet attached to the printed circuit board, wherein the improvement comprises:
a conductive material layer coated on the entire surface of the EL sheet or the surface of the EL sheet where light is not emitted, the conductive material layer being connected to the ground of the printed circuit board by means of a conductive adhesive tape or conductive paste.

2. An EL sheet keypad comprising: a printed circuit board; and an EL sheet attached to the printed circuit board while a drive circuit of the EL sheet is connected to ground of the printed circuit board, wherein the improvement comprises:
a conductive material layer coated on the entire surface of the EL sheet or the surface of the EL sheet where light is not emitted, the conductive material layer being connected to front electrodes for supplying electric current to the drive circuit by means of a conductive adhesive tape or conductive paste.

3. The keypad as set forth in claim 1, wherein the conductive material layer is formed in a net pattern including empty spaces each having a diameter of not more than 0.6 mm.

4. The keypad as set forth in claim 2, wherein the conductive material layer is formed in a net pattern including empty spaces each having a diameter of not more than 0.6 mm.
